(19) United States
(12) Patent Application Publication
(10) Pub. No.: US 2004/0133595 A1
(43) Pub. Date: Jul. 8, 2004

(54) Generation of persistent document object models

(76) Inventor: Karl S. Black, Nampa, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/338,401

(22) Filed: Jan. 8, 2003

(51) Int. Cl. G06F 17/00

(52) U.S. Cl. 707/103 Y

(57) ABSTRACT

Various systems, methods, and computer programs embodied in a computer readable medium are provided for the persistence of document object models for use in creating markup documents by copying and alteration, etc. In one embodiment, a method is provided that comprises the steps of parsing a markup document into document object model (DOM), inputting a selection of a number of DOM elements of the DOM that are to be included in a template, creating the template and storing the template in a nonvolatile memory, conditioning selected ones of the DOM elements to be added to the template, and, adding the selected ones of the DOM elements to the template in the nonvolatile memory.

### CROSS REFERENCE TO RELATED APPLICATIONS

This application is related to U.S. patent application entitled “PERSISTENT DOCUMENT OBJECT MODEL” filed on even date herewith and afforded Ser. No. ______ (Attorney Docket Number 100202848-1).

### BACKGROUND

The creation of markup documents that are employed, for example, as pages available on the Internet using the World Wide Web can be time consuming. Also, a relatively high degree of technical competency is required to create markup documents, etc. Due to the time involved and the required technical skill, the cost to create markup documents or pages can be significant. For example, a web site created using an appropriate markup language such as Hypertext Markup Language (HTML) or Extensible Markup Language (XML) can be significant to the average businesses that need a presence on the World Wide Web.

Sometimes in creating a web site or other markup document, a programmer might copy code from an existing markup file into a new markup file to copy a feature of a markup page, etc. This speeds up the process of generating a new markup page or file by reducing the amount of original programming that has to be performed. Unfortunately, copying portions of existing markup files or pages can also be time consuming and requires the technical skill to recognize the portions of code in such existing markup files or pages that is to be copied.

### SUMMARY

In light of the foregoing, the present invention provides for the persistence of document object models for use in creating markup documents by copying and alteration, etc. Specifically, the present invention provides for methods, systems, and programs embodied in computer readable mediums for persisting document object models. In one embodiment, a method is provided that comprises the steps of parsing a markup document into document object model (DOM), inputting a selection of a number of DOM elements of the DOM that are to be included in a template, creating the template and storing the template in a nonvolatile memory, conditioning selected ones of the DOM elements to be added to the template, and, adding the selected ones of the DOM elements to the template in the nonvolatile memory.

In another embodiment, a program embodied in a computer readable medium is provided for generating persistent document object models. In this respect, the computer program comprises a parser that parses a markup document into document object model (DOM) and code that inputs a selection of a number of DOM elements of the DOM that are to be included in a template. The program also comprises code that creates the template and stores the template in a nonvolatile memory, and code that conditions selected ones of the DOM elements to be added to the template. Also, the program comprises code that adds the selected ones of the DOM elements to the template in the nonvolatile memory.

In yet another embodiment, a system for generating persistent document object models is provided. In this respect, the system comprises a processor circuit having a processor and a memory. A persistent document object model (PDOM) parser is stored in the memory and is executable by the processor. The PDOM parser comprises a parser that parses a markup document into document object model (DOM), logic that inputs a selection of a number of DOM elements of the DOM that are to be included in a template, and logic that creates the template and stores the template in a nonvolatile portion of the memory. In addition, the PDOM parser also comprises logic that conditions selected ones of the DOM elements to be added to the template, and logic that adds the selected ones of the DOM elements to the template in the nonvolatile portion of the memory.

In still another embodiment, a system for generating persistent document object models is provided that comprises a parser that parses a markup document into document object model (DOM), means for inputting a selection of a number of DOM elements of the DOM that are to be included in a template, and means for creating the template and storing the template in a nonvolatile portion of the memory. The system also includes means for conditioning selected ones of the DOM elements to be added to the template, and means for adding the selected ones of the DOM elements to the template in the nonvolatile portion of the memory.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE DRAWINGS

The invention can be understood with reference to the following drawings. The components in the drawings are not necessarily to scale. Also, in the drawings, like reference numerals designate corresponding parts throughout the several views.

FIG. 1 depicts a block diagram of a computer system that is employed to execute a persistent document object model (PDOM) parser according to an embodiment of the present invention;

FIG. 2A depicts a drawing of an exemplary markup document that illustrates the format of markup documents processed by the PDOM parser of FIG. 1;

FIG. 2B depicts a drawing of a tree that represents a document object model (DOM) that illustrates a structure of a DOM created and further processed by the PDOM parser of FIG. 1;

FIG. 3 depicts a drawing of a user interface generated by the PDOM parser of FIG. 1 to facilitate a selection of DOM elements in a DOM that are stored within a template in a template database; and

FIGS. 4A and 4B depict an exemplary flow chart of the PDOM parser of FIG. 1 according to an embodiment of the present invention.

### DETAILED DESCRIPTION

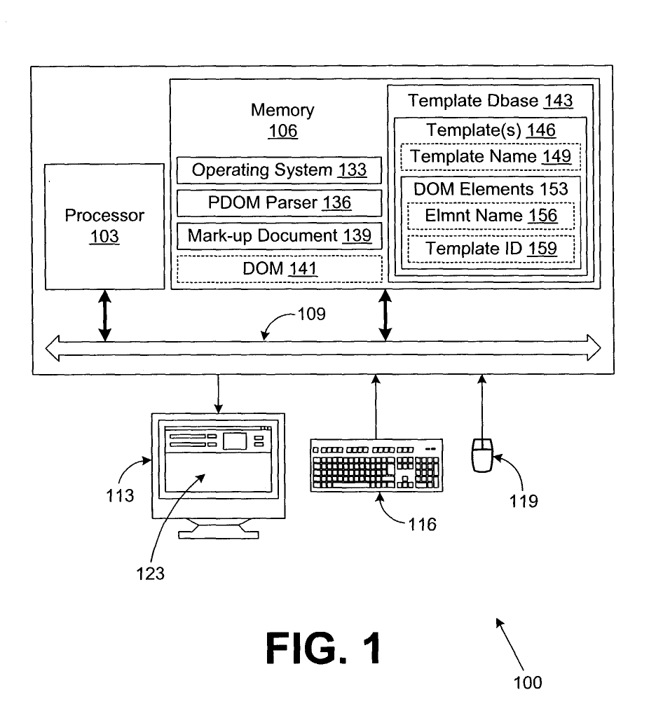

With reference to FIG. 1, shown is a block diagram of a computer system 100 according to an embodiment of present invention. The computer system 100 includes a processor circuit having a processor 103 and the memory 106, both of which are coupled to a local interface 109. Local interface 109 may be, for example, a data bus with an accompanying control/address bus as can be appreciated by those with ordinary skill in the art. In this respect, the computer system 100 may be, for example, any computer system or other device with like capability.

The computer system 100 includes one or more peripheral devices such as, for example, a display device 113, a keyboard 116, and a mouse 119. The keyboard 116 and mouse 119 may be manipulated to provide user input to the computer system 100 as can be appreciated by those with ordinary skill in the art. The computer system 100 generates various displays including user interfaces on the display device 113 as will be discussed.

In addition, other peripheral devices may be employed as part of the computer system 100 such as, for example, keypad, touch pad, touch screen, microphone, scanner, joystick, or one or more push buttons, etc. The peripheral devices may also include indicator lights, speakers, printers, etc. The display device 113 may be, for example, a cathode ray tube (CRT), liquid crystal display screen, gas plasma-based flat panel display, or other type of display device, etc.

A number of software components are stored in memory 106 and are executable by the processor 103 according to an aspect of present invention. These software components include, for example, an operating system 133, a Persistent Document Object Model (PDOM) parser 136, one or more markup documents 139, a Document Object Model (DOM) 141 and a template database 143. The DOM 141 is temporarily created and stored in the memory 106 as will be discussed. Stored within the template database 143 are a number of templates 146. Each of the templates 146 is identified by a template name 149. Each of the templates 146 also includes one or more DOM elements 153. Each of the DOM elements 153 is identified with an element name 156 and is associated with the template 146, for example, using a template identifier 159. Each of the DOM elements 153 comprises a portion or node of the DOM 141 that is generated from the markup document 139 as will be discussed.

The templates 146 are “forms” of documents that can ultimately be translated into an appropriate markup language. In this regard, the templates 146 store all of the DOM elements 153 of a particular a DOM 141 using the language of the DOM 141 itself. The templates 146 may thus be used to create new documents such as web sites, for example, or other documents that are expressed in an appropriate markup language. Specifically, rather than creating a web site or other document in a markup language such as HTML or XML, a user may access templates 146 stored in a nonvolatile portion of the memory 106.

The memory 106 is defined herein as both volatile and nonvolatile memory and data storage components. Volatile components are those that do not retain data values upon loss of power. Nonvolatile components are those that retain data upon a loss of power. Thus, the memory 106 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 103 may represent multiple processors and the memory 106 may represent multiple memories that operate in parallel. In such a case, the local interface 109 may be an appropriate network that facilitates communication between any two of the multiple processors, between any processor and any one of the memories, or between any two of the memories etc.

The operating system 133 is executed to control the allocation and usage of hardware resources in the computer system 100 such as the memory, processing time and peripheral devices. In this manner, the operating system 133 serves as the foundation on which applications depend as is generally known by those with ordinary skill in the art.

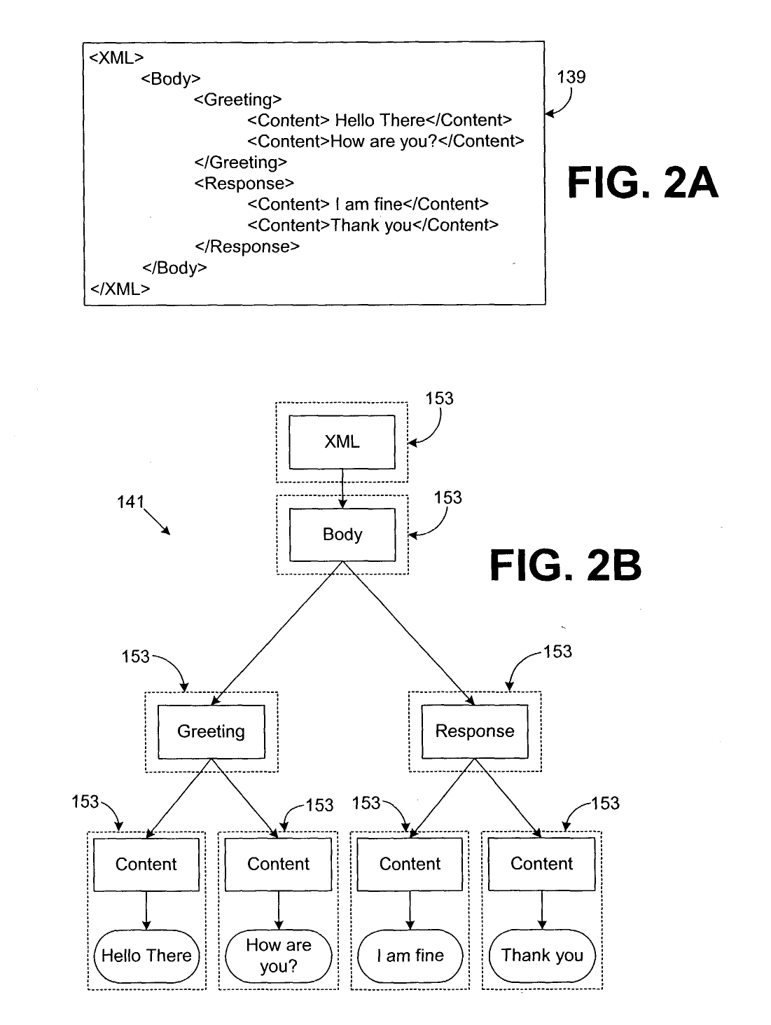

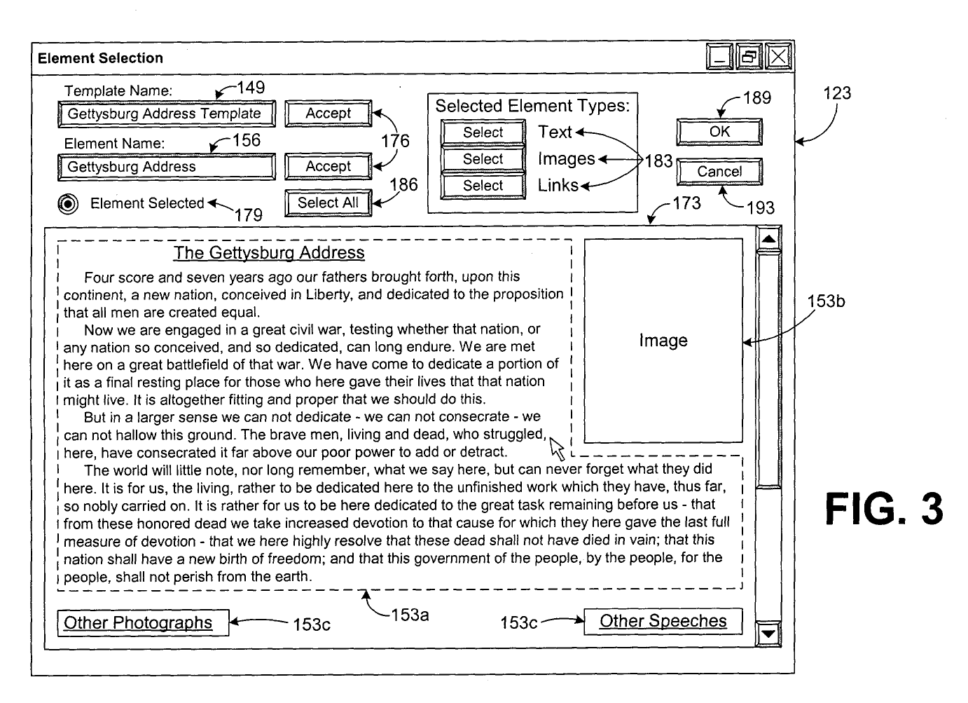

With reference to FIG. 2A, shown is an example of a markup document 139 in the form of an XML document to provide an illustration of an original document that may be represented by a corresponding DOM 141. As shown, the XML document includes a number of tags or nodes and content items that are nested in accordance with the organization of the document.

Referring then, to FIG. 2B, shown is a representation of the above markup document 139 in the form of a DOM 141. As shown, the DOM 141 has a logical structure that is much like a tree. In this sense, the DOM 141 includes a number of DOM elements 153 that can also be described as “nodes”. The DOM elements 153 are depicted in FIG. 2B without regard to their nature or type. That is to say, each of the DOM elements 153 may include characteristics that differ from the characteristics of the remaining ones of the DOM elements 153. A DOM 141 is an “object model” in the traditional object oriented design sense. That is to say, documents are modeled using objects, and the model encompasses not only the structure of the document, but also the behavior of a document and the objects of which it is composed. In other words, the nodes or DOM elements 153 shown in FIG. 2 represent more than just a data structure, they represent objects that have functions and identity.

In this sense, a DOM 141 is defined as a memory resident object representation of a data structure embodied in a markup language such as such as HTML, XML, or other markup language. As contemplated herein, the term “document” refers to a document that is rendered and viewed by an individual using, for example, a display device, printer, or other device.

The Document Object Model allows programmers to build documents, navigate their structure, and add, modify, or delete elements or content. Although there are some exceptions, generally any layout or content information found in an HTML or XML document or other type of Markup document can be accessed, changed, deleted, or added using a DOM 141.

As an object model, a DOM 141 identifies the interfaces and objects used to represent and manipulate a document, the semantics of these interfaces and objects including both behavior and attributes, and the relationships and collaborations among these interfaces and objects. In this sense, a DOM 141 specifies how XML, HTML, or other markup documents 139 may be represented as objects so that they may be used in object oriented programs and the like. Thus, a DOM 141 provides an object model that specifies interfaces in the sense that, although a document contains diagrams showing parent/child relationships, these are logical relationships defined by the programming interfaces, not representations of any particular internal data structures. To obtain greater detail about DOMs 141 as described herein, reference is made to Wood et al., Document Object Model (DOM) Level 1 Specification, Version 1.0, W3C Recommendation, 1 Oct. 1998, which is incorporated herein in its entirety.

While a DOM 141 allows programmers to build documents, navigate their structure, and add, modify, or delete elements or content, the ultimate expression of the layout and content expressed therein is stored in non-volatile memory as a markup file such as, for example, an HTML or XML document. In other words, a DOM 141 is expressed in a format that allows for storage and manipulation in random access memory (RAM). When a document expressed as a DOM 141 is stored in non-volatile memory such as, for example, a hard drive, disk drive, etc., the document is translated back into the markup language from which it came such as HTML, XML, or other markup language as is conventional.

The PDOM parser 136 provides for the creation of “persistent” DOMs 141 from markup documents 139. The persistent DOMs 141 are stored in the template database 143 as templates 146. In this sense, the DOM 141 becomes a persistent DOM 141 as it “persists” beyond the actual run time when it is stored and accessed in RAM by a given application. As a result, a user can create a template 146 out of any markup document 139 with very little effort expended. The templates 146 may then be employed to create new markup documents 139 with a similar appearance. Also, users may easily make desired changes to such templates 146 when creating new markup documents 139 that vary in their appearance, but employ at least some of the elements of the original templates 146. Thus, the templates 146 are reusable to create further markup documents 139 therefrom.

To provide for future accessibility and modification, the templates 146 include the DOM elements 153 in a form that maintains the interfaces and objects used to represent and manipulate a document, the semantics of these interfaces and objects including both behavior and attributes, and the relationships and collaborations among these interfaces and objects. Also, the layout data contained in the DOM 141 is separated from the content data so that the layout inherent in the DOM 141 may be accessed for future use with different content as will be discussed.

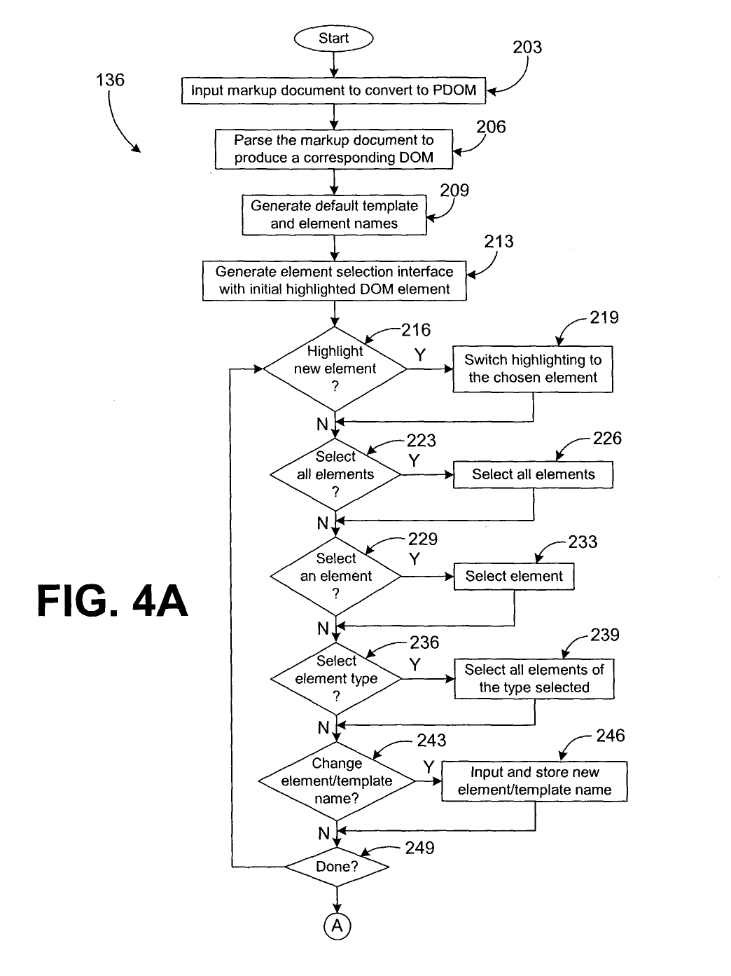

With reference to FIG. 3, shown is an exemplary user interface 123 that is generated by the PDOM parser 136 according to an embodiment of the present invention. The user interface 123 described herein is merely an example of the many different types of user interfaces that can be created using any one of a large variety of graphical components to accomplish the inputting and selection functions and any other user interface functions described herein.

The user interface 123 includes a graphical display of a document 173 represented by the DOM 141 is displayed. As shown, the document 173 includes a number of DOM elements 153 such as, for example, text elements 153a, image elements 153b, link elements 153c, and other types of DOM elements 153 that are generated on the display device 113 (FIG. 1) by the PDOM parser 136. Any one of the DOM elements 153 may be highlighted, for example, providing appropriate input using the keyboard 116 (FIG. 1) or the mouse 119, or other input device. A highlighted DOM element 153 is indicated, for example, by surrounding such an element with a special boarder or by changing some other characteristic of the DOM element 153, etc.

The user interface 123 also depicts a template name 149 that identifies the template 146 that is to be generated by the PDOM parser 136 based upon the currently displayed DOM 141. The user interface 123 also depicts an element name 156 that is associated with the current highlighted DOM element 153. As other DOM elements 153 are highlighted, the corresponding element name 156 is displayed. Initially, the PDOM parser 136 generates default names for each of the DOM elements 153 before generating the user interface 123 based upon the substance of the DOM elements 153 themselves. A user may alter the template name 149 and/or an element name 156 and then manipulate the appropriate “accept” button 176 to store the new name in memory.

In addition, the user interface 123 includes an element selector 179 that indicates a selection status of the respective highlighted DOM element 153. To select a highlighted DOM element 153, a user may manipulate the element selector 179 accordingly. Each of the DOM elements 153 may have a selection status that is either “selected” or “not selected”. Although a toggle mechanism is depicted to indicate the selection status of each of the DOM elements 153, it is understood that other types of indicators may be employed.

The user interface 123 also includes element type selectors 183 that allow a user to select all DOM elements 153 of a specific type. The element types may include, for example, text elements, image elements, link elements (such as hyperlinks), and other types of elements. By manipulating one of the element type selectors 183, the PDOM parser 136 selects each of the DOM elements 153 that are of the type chosen. In this respect, the selection status of all DOM elements 153 of the type selected is altered to “selected” and, for each of these DOM elements 153, the element selector 179 reflects the updated status. Alternatively, the user may manipulate the “Select All” button 186 to select all of the DOM elements 153 in the document 173.

In any event, when the user has completed the process of selecting the DOM elements 153 that they wish to include in the template 146 that is to be created using any one or more of the selection mechanisms described above, then they may manipulate the “OK” button 189. In response thereto, the PDOM parser 136 proceeds to create the template 146 and store the selected DOM elements 153 therein. Alternatively, the user may manipulate the “cancel” button 193 to abandon the process of creating the template 146.

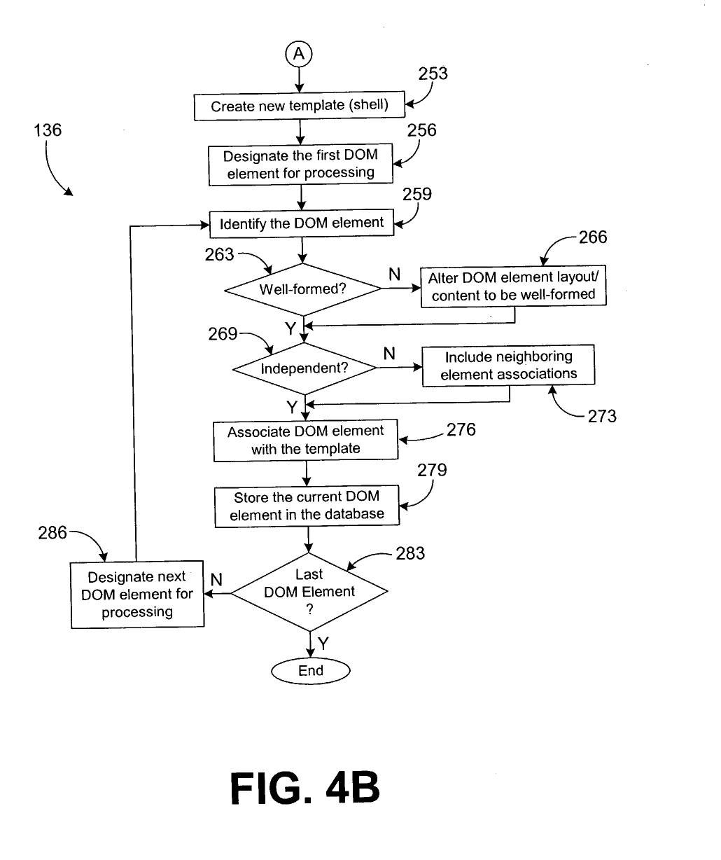

Turning then, to FIGS. 4A and 4B, shown is a flow chart that provides an example illustration of the operation of the PDOM parser 136 according to an embodiment of the present invention. Alternatively, the flow chart of FIGS. 4A and 4B may be viewed as depicting steps of a method implemented in the computer system 100 (FIG. 1) to generate the templates 146 (FIG. 1) from the markup documents 139 (FIG. 1), where the templates 146 provide a means by which a DOM 141 (FIG. 1) generated from the markup document 139 is persisted in a nonvolatile portion of the memory 106 (FIG. 1).

The PDOM parser 136 may be written in any one of a number of programming languages such as, for example, C++, Java™, Pearl, Java Server Pages (JSP), Extensible Stylesheet Language (XSL) or other appropriate programming languages, or a combination of any two or more of such programming languages. In addition, the underlying functionality described herein may be encapsulated in various ones of a number of objects in an object oriented architecture, where the details of the architecture are left to the ordinary programmer as an implementation issue.

Beginning with box 203, the PDOM parser 136 inputs a markup document 139 that is to be stored as a template 146 in the template database 143 (FIG. 1), thereby creating a persistent DOM 141. The markup document 139 may be input using an appropriate browsing function or via some other approach. Thereafter, in box 206 the markup document 139 is parsed to produce a corresponding DOM 141. Next, in box 209 the PDOM parser 136 generates a default template name 149 and element names 156 for each of the DOM elements 153 included in the DOM 141. Thereafter, in box 213 the user interface 123 (FIG. 3) is generated on the display device 113 (FIG. 1). Also, in the user interface 123, an initial one of the DOM elements 153 is highlighted with its corresponding element name 156 displayed.

Next, in box 216 the PDOM parser 136 determines if a new one of the DOM elements 153 has been highlighted. If so, then the PDOM parser 136 proceeds to box 219. Otherwise the PDOM parser 136 moves to box 223. In box 219 the highlighting is switched from the previously chosen DOM element 153 to the newly chosen DOM element 153. In doing so, the PDOM parser 136 may remove the highlighting from the previously chosen DOM element 153 and impose highlighting on the newly chosen DOM element 153. Thereafter, the PDOM parser 136 proceeds to box 223.

Next, in box 223 the PDOM parser 136 determines if all DOM elements 153 have been selected, for example, by the manipulation of one of the “Select All” button 186 (FIG. 3). If so, then the PDOM parser 136 proceeds to box 226. Otherwise the PDOM parser 136 moves to box 229. In box 226 the selection status of all of the DOM elements 153 in the DOM 141 that do not already have a selection status of “selected” are altered to a status of “selected”. Also, if the current highlighted DOM element 153 previously had a selection status of “not selected”, then the appearance of the element selector 179 is altered to indicate the “selected” status of the specific DOM element 153. Thereafter, the PDOM parser 136 proceeds to box 229.

In box 229 the PDOM parser 136 determines if a specific DOM element 153 has been selected, for example, by manipulation of the element selector 179 (FIG. 3). If so, then the PDOM parser 136 proceeds to box 233. Otherwise the PDOM parser 136 moves to box 236. In box 233 the selection status of the selected DOM element 153 is altered to “selected”. Also, the appearance of the element selector 179 is altered to indicate the “selected” status of the specific DOM element 153. Thereafter, the PDOM parser 136 proceeds to box 236.

Next, in box 236 the PDOM parser 136 determines if an element type has been selected, for example, by the manipulation of one of the element type selectors 183 (FIG. 3). If so, then the PDOM parser 136 proceeds to box 239. Otherwise the PDOM parser 136 moves to box 243. In box 239 the selection status of all DOM elements 153 of the type selected by the appropriate element type selector 183 is altered to a status of “selected” if their selection status is not already indicated as “selected”. Also, if one of the DOM elements 153 of the type selected is highlighted, then the appearance of the element selector 179 is altered to indicate the “selected” status of the specific DOM element 153 unless the selection status was already indicated as “selected”. Thereafter, the PDOM parser 136 proceeds to box 243.

Next, in box 243 the PDOM parser 136 determines if a template name 149 or element name 156 has been altered by a manipulation of one of the change buttons 176 (FIG. 3). If so, then the PDOM parser 136 proceeds to box 246. Otherwise the PDOM parser 136 moves to box 249. In box 246 the PDOM parser 136 alters the appropriate name in the memory 106 (FIG. 1) to be employed in storing the template 149 or DOM element 153 in the template database 143 (FIG. 1). Thereafter, the PDOM parser 136 proceeds to box 249.

Next, in box 249 the PDOM parser 136 determines if the user has completed the selection of DOM elements 153 and the performance of all other functions provided by the user interface 123 as indicated by a manipulation of the “OK” button 189. If so, then the PDOM parser 136 proceeds to box 253 of FIG. 4B. Otherwise the PDOM parser 136 reverts back to box 216 as shown. Also, the PDOM parser 136 cancels the processing of the current DOM 141 upon an implementation of the cancel button 193 (FIG. 3), where such a function is not included in the flow chart of FIG. 4A.

Thereafter, in box 253 the PDOM parser 136 creates a new template 146 in the template database 143 that is to be used to store the DOM elements 153. The template name 149 is associated with the template 146 in its present form. The newly created template 146 is a “shell” template in that it does not include any DOM elements 153. Then, in box 256 a first one of the selected DOM elements 153 is designated for processing to be placed in the template 146. Then, in box 259 the DOM element 153 is specifically identified within the DOM 141. In this respect, a starting point and an ending point of the DOM element 153 are identified based upon a predefined understanding of the syntax employed in the DOM 141.

In the following boxes, the PDOM parser 136 conditions the current selected DOM element 153 to be added to the template 146 created in box 253. Specifically, in box 263 the PDOM parser 136 determines if the currently designated DOM element 153 is well-formed according to a set of rules that apply to the creation of the DOM 141. This is done, for example, as the DOM element 153 may not be well-formed when taken from the context of the DOM 141 itself. The set of rules may be, for example, those that apply to the creation of a DOM 141 as set forth by Wood et al., Document Object Model (DOM) Level 1 Specification, Version 1.0, W3C Recommendation, 1 Oct. 1998 referenced above, or some other set of rules may apply. If the DOM element 153 is not well-formed, then the PDOM parser 136 proceeds to box 266. Otherwise the PDOM parser 136 moves to box 269. In box 266, the current DOM element 153 is altered so as to be well-formed. The precise alterations may entail, for example, the inclusion of closing tags where they are not present or the inclusion of information relating to neighboring relationships with other DOM elements 153 such as the case where a particular DOM element 153 is a cell within a table or other structure, etc. Thereafter, the PDOM parser 136 moves to box 269.

In box 269, the PDOM parser 136 determines whether the current DOM element 153 is independent from other DOM elements 153 in that there are no neighboring associations, etc., to include with the DOM element 153. The neighboring associations may entail, for example, relationships between two of the DOM elements 153, etc. If the DOM element 153 is not independent, then the PDOM parser 136 proceeds to box 273. Otherwise the PDOM parser 136 moves to box 276. In box 273, all existing neighboring associations with other DOM elements 153, etc., are included in the current DOM element 153. Also, any nonexistent neighboring associations required for syntactic correctness and/or semantic visual coherence are created and added to the current DOM element 153. Thereafter, the PDOM parser 136 proceeds to box 276.

In box 276, the current DOM element 153 is associated with the template 146. This may be done, for example, by associating a template identifier 159 (FIG. 1) with the DOM element 153. The template identifier 159 may be, for example, the template name 149 or some other appropriate designation. Thereafter, in box 279 the current DOM element 153 is stored as a portion of the current template 146 in the template database 143. In this respect, the DOM 141 becomes a persistent DOM in that the elements contained within the DOM 141 are stored in a nonvolatile portion of the memory 106 (FIG. 1) in the template database 143.

Next, in box 283 the PDOM parser 136 determines if the last selected DOM element 153 has been processed and included in the template 146 in the template database 143. If so, then the PDOM parser 136 ends as shown. Otherwise the PDOM parser 136 moves to box 286 in which the next selected DOM element 153 is designated for processing. Thereafter, the PDOM parser 136 reverts back to box 259 as shown.

Although the PDOM parser 136 is depicted as being embodied in software or code executed by general purpose hardware as discussed above, as an alternative the same may also be embodied in dedicated hardware or a combination of software/general purpose hardware and dedicated hardware. If embodied in dedicated hardware, the PDOM parser 136 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIGS. 4A and 4B shows an example of the architecture, functionality, and operation of an implementation of the PDOM parser 136. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIGS. 4A and 4B shows a specific order of execution, it is understood that the order of execution may differ from that which is depicted. For example, the order of execution of two or more blocks may be scrambled relative to the order shown. Also, the functions of two or more blocks shown in succession in FIGS. 4A and 4B may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the PDOM parser 136 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the PDOM parser 136 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A method for generating persistent document object models, comprising the steps of:
parsing a markup document into document object model (DOM);
inputting a selection of a number of DOM elements of the DOM that are to be included in a template;
creating the template and storing the template in a nonvolatile memory;
conditioning selected ones of the DOM elements to be added to the template; and
adding the selected ones of the DOM elements to the template in the nonvolatile memory.

2. The method of claim 1, further comprising the steps of:
accessing the template in the nonvolatile memory; and
generating a second markup document from the template.

3. The method of claim 1, wherein the step of inputting the selection of the number of DOM elements of the DOM that are to be included in the template further comprises the step of presenting a user interface on a display device that facilitates a selection of the number of DOM elements of the DOM by a user.

4. The method of claim 1, wherein the step of inputting the selection of the number of DOM elements of the DOM that are to be included in the template further comprises the step of:
inputting a selection of at least one DOM element type; and
automatically selecting each of the DOM elements that are of the at least one DOM element type to be included in the template.

5. The method of claim 1, wherein the step of conditioning selected ones of the DOM elements to be added to the template further comprises the steps of:
determining whether at least one of the selected ones of the DOM elements is well-formed according to a set of predefined rules; and
modifying the at least one of the selected ones of the DOM elements to be well-formed according to the set of predefined rules if it is determined that the at least one of the selected ones of the DOM elements is not well-formed.

6. The method of claim 1, wherein the step of conditioning selected ones of the DOM elements to be added to the template further comprises the steps of modifying at least one of the selected ones of the DOM elements to include a neighboring association with another one of the selected ones of the DOM elements.

7. The method of claim 1, wherein the step of adding the selected ones of the DOM elements to the template in the nonvolatile memory further comprises the step of storing the selected ones of the DOM elements in the nonvolatile memory in association with the template.

8. A program embodied in a computer readable medium for generating persistent document object models, comprising:
a parser that parses a markup document into document object model (DOM);
code that inputs a selection of a number of DOM elements of the DOM that are to be included in a template;
code that creates the template and stores the template in a nonvolatile memory;
code that conditions selected ones of the DOM elements to be added to the template; and
code that adds the selected ones of the DOM elements to the template in the nonvolatile memory.

9. The program embodied in the computer readable medium of claim 8, wherein the template is reusable to create a second markup document therefrom.

10. The program embodied in the computer readable medium of claim 8, wherein the code that inputs the selection of the number of DOM elements of the DOM that are to be included in the template further comprises code that generates a user interface on a display device that facilitates a selection of the number of DOM elements of the DOM by a user.

11. The program embodied in the computer readable medium of claim 8, wherein the code that inputs the selection of the number of DOM elements of the DOM that are to be included in the template further comprises:
code that inputs a selection of at least one DOM element type; and
code that automatically selects each of the DOM elements that are of the at least one DOM element type to be included in the template.

12. The program embodied in the computer readable medium of claim 8, wherein the code that conditions selected ones of the DOM elements to be added to the template further comprises:
code that determines whether at least one of the selected ones of the DOM elements is well-formed according to a set of predefined rules; and
code that modifies the at least one of the selected ones of the DOM elements to be well-formed according to the set of predefined rules if it is determined that the at least one of the selected ones of the DOM elements is not well-formed.

13. The program embodied in the computer readable medium of claim 8, wherein the code that conditions selected ones of the DOM elements to be added to the template further comprises code that modifies at least one of the selected ones of the DOM elements to include a neighboring association with another one of the selected ones of the DOM elements.

14. The program embodied in the computer readable medium of claim 8, wherein the code that adds the selected ones of the DOM elements to the template in the nonvolatile memory further comprises code that stores the selected ones of the DOM elements in the nonvolatile memory in association with the template.

15. A system for generating persistent document object models, comprising:
a processor circuit having a processor and a memory;
a persistent document object model (PDOM) parser stored in the memory and executable by the processor, the PDOM parser comprising:
a parser that parses a markup document into document object model (DOM);
logic that inputs a selection of a number of DOM elements of the DOM that are to be included in a template;
logic that creates the template and stores the template in a nonvolatile portion of the memory;
logic that conditions selected ones of the DOM elements to be added to the template; and
logic that adds the selected ones of the DOM elements to the template in the nonvolatile portion of the memory.

16. The system of claim 15, wherein the template is reusable to generate a second markup document therefrom.

17. The system of claim 15, wherein the logic that inputs the selection of the number of DOM elements of the DOM that are to be included in the template further comprises logic that generates a user interface on a display device that facilitates a selection of the number of DOM elements of the DOM by a user.

18. The system of claim 15, wherein the logic that inputs the selection of the number of DOM elements of the DOM that are to be included in the template further comprises:
logic that inputs a selection of at least one DOM element type; and
logic that automatically selects each of the DOM elements that are of the at least one DOM element type to be included in the template.

19. The system of claim 15, wherein the logic that conditions selected ones of the DOM elements to be added to the template further comprises:
logic that determines whether at least one of the selected ones of the DOM elements is well-formed according to a set of predefined rules; and
logic that modifies the at least one of the selected ones of the DOM elements to be well-formed according to the set of predefined rules if it is determined that the at least one of the selected ones of the DOM elements is not well-formed.

20. The system of claim 15, wherein the logic that conditions selected ones of the DOM elements to be added to the template further comprises logic that modifies at least one of the selected ones of the DOM elements to include a neighboring association with another one of the selected ones of the DOM elements.

21. The system of claim 15, wherein the logic that adds the selected ones of the DOM elements to the template in the nonvolatile portion of the memory further comprises logic that stores the selected ones of the DOM elements in the nonvolatile portion of the memory in association with the template.

22. A system for generating persistent document object models, comprising:
a parser that parses a markup document into document object model (DOM);
means for inputting a selection of a number of DOM elements of the DOM that are to be included in a template;
means for creating the template and storing the template in a nonvolatile portion of the memory;
means for conditioning selected ones of the DOM elements to be added to the template; and
means for adding the selected ones of the DOM elements to the template in the nonvolatile portion of the memory.

23. The system of claim 22, wherein the template is reusable to generate a second markup document therefrom.

24. The system of claim 22, wherein the means for inputting the selection of the number of DOM elements of the DOM that are to be included in the template further comprises means for generating a user interface on a display device that facilitates a selection of the number of DOM elements of the DOM by a user.

25. The system of claim 22, wherein the means for inputting the selection of the number of DOM elements of the DOM that are to be included in the template further comprises:
means for inputting a selection of at least one DOM element type; and
means for automatically selecting each of the DOM elements that are of the at least one DOM element type to be included in the template.
